(19) United States
(12) Patent Application Publication
(10) Pub. No.: US 2020/0265821 A1
(43) Pub. Date: Aug. 20, 2020

(54) METHOD FOR PRODUCING AN ACOUSTIC ABSORPTION STRUCTURE COMPRISING A SKIN FORMING A PLURALITY OF ENCLOSURES, ACOUSTIC ABSORPTION STRUCTURE OBTAINED ACCORDING TO SAID METHOD AND AIRCRAFT COMPRISING SAID ACOUSTIC ABSORPTION STRUCTURE

(71) Applicant: Airbus Operations SAS, Toulouse (FR)

(72) Inventors: Theo RICCOBENE, REZE (FR); Franck DOBIGEON, NANTES (FR)

(21) Appl. No.: 16/789,065

(22) Filed: Feb. 12, 2020

(30) Foreign Application Priority Data
Feb. 14, 2019 (FR) 1901469

(51) Int. Cl. G10K 11/168

(52) U.S. Cl. CPC G10K 11/168; B32B 3/12

(57) ABSTRACT

A method for producing an acoustic absorption structure comprising an acoustically resistive structure, an alveolar structure, a reflective layer and a plurality of acoustic elements positioned in the alveolar structure, against the acoustically resistive structure, the method comprising forming a skin forming enclosures of the acoustic elements by depositing a resin on a mold having a base on which are positioned projecting forms shaped like the cavities delimited by the enclosures of the acoustic elements, placing the mold supporting the resin together with the alveolar structure, the resin being intercalated between the mold and the alveolar structure, polymerizing the resin to simultaneously obtain a hardening of the skin and also the joint between the skin and the alveolar structure, and fitting the acoustically resistive structure and the reflective layer.

### CROSS-REFERENCES TO RELATED APPLICATIONS

This application claims the benefit of the French patent application No. 1901469 filed on Feb. 14, 2019, the entire disclosures of which are incorporated herein by way of reference.

### BACKGROUND OF THE INVENTION

The present application relates to a method for producing an acoustic absorption structure comprising a skin forming a plurality of enclosures, to an acoustic absorption structure obtained according to the method and also to an aircraft comprising the acoustic absorption structure.

### BACKGROUND OF THE INVENTION

According to a prior art embodiment, a propulsive assembly comprises a nacelle and also a bypass turbo engine, positioned inside the nacelle. Certain surfaces of the nacelle and of the turbo engine comprise acoustic absorption structures for attenuating noise pollution. According to one embodiment, an acoustic absorption structure comprises a porous layer, a honeycomb alveolar layer and a reflective layer.

A “UHBR” (Ultra High Bypass Ratio) turbo engine has a fan turning at frequencies that are lower than certain turbo engines currently on the market and therefore the acoustic absorption structures have to be configured such as to attenuate soundwaves at low frequencies. In order to attenuate such soundwaves, the honeycomb alveolar layer has to have a significant height, which is detrimental in terms of mass, overall size and manufacture.

An acoustic absorption structure that makes it possible to absorb soundwaves at low frequencies is described in the document entitled “Aero-acoustic liner applications of the broadband special acoustic absorber concept, American Institute of Aeronautics and Astronautics, AIAA 2013-2176, 19th AIAA/CEAS Aeroacoustics Conference May 27-29, 2013, Berlin, Germany”. According to an embodiment that can be seen in FIGS. 1 and 2, an acoustic absorption structure 10 comprises a porous layer 12 in contact with a medium in which soundwaves propagate, an alveolar structure 14, a reflective layer 16 and also a plurality of acoustic elements 18. Each of them comprises a capsule 20 closed by the porous layer 12 such as to delimit a cavity 22 in which is positioned a hollow cone 24, remote from the capsule 20, which has an aperture 26 opening out at the porous layer 12. Each cone 24 comprises at least one acoustic orifice 28 allowing communication between the interior of the cone 24 and the space between the cone 24 and the capsule 20, positioned and dimensioned as a function of the desired acoustic characteristics.

An acoustic absorption structure 10 thus formed, based on the same principle as a Helmholtz resonator and a quarter-wave resonator, makes it possible efficiently to attenuate the low-frequency sounds emitted by a UHBR-type turbo engine.

According to another embodiment, each acoustic element comprises a capsule closed by the porous layer, positioned in the alveolar structure 14.

According to one operating method, the acoustic elements 18 are produced, independently of one another, by molding or by injection, from resin with a short-fiber or fibreless filler and are positioned in impressions 30 machined in the alveolar structure 14. The acoustic elements 18 are connected to the alveolar structure 14 by adhesive bonding or by embedding.

This operating method is not completely satisfactory because all the acoustic elements 18 have to be individually handled and positioned in the impressions 30 of the alveolar structure 14. Furthermore, linking the acoustic elements 18 and the alveolar structure 14 by adhesive bonding or by embedding tends to stiffen the acoustic absorption structure 10 thus obtained, which may then be difficult to match to the form of a cylindrical conduit of an aircraft nacelle. Lastly, this embodiment is detrimental in terms of mass.

The present invention aims to remedy all or some of the prior art drawbacks.

### SUMMARY OF THE INVENTION

To that end, the invention relates to a method for producing an acoustic absorption structure comprising an acoustically resistive structure, an alveolar structure, a reflective layer and also a plurality of acoustic elements each comprising an enclosure positioned in the alveolar structure and having an opening delimited by an edge placed against the acoustically resistive structure such that the enclosure and the acoustically resistive structure delimit a cavity.

According to the invention, the method comprises a step of forming a skin forming the enclosures of the acoustic elements by depositing a resin on a mold having a base on which are positioned projecting forms shaped like the cavities of the acoustic elements, a step of placing the mold supporting the resin together with an alveolar structure, the resin being intercalated between the mold and the alveolar structure, a step of polymerization of the resin to simultaneously obtain a hardening of the skin and also the joint between the skin and the alveolar structure, and a step of fitting the acoustically resistive structure and the reflective layer.

The method of the invention makes it possible simultaneously to obtain a multitude of enclosures with a relatively thin thickness as compared with that of the enclosures of prior art acoustic elements obtained by injection, which contributes to reducing the mass of the acoustic elements.

According to another feature, the mold is produced from a deformable or flexible material.

According to a first variant, the resin is configured such as to confer a stiffness on the skin after the polymerization step, the mold having a base shaped like the acoustic absorption structure to be produced.

According to a second variant, the resin is configured such as to obtain a flexible skin after the polymerization step.

According to one embodiment, the resin is a polyurethane/epoxy mixed resin.

According to one embodiment, the resin is in the form of a film deformed or thermoformed on the mold.

According to another embodiment, the resin is in the liquid or pasty state and deposited on the mold by spraying, by coating or by dipping.

According to another feature, the resin is positioned between the mold and a countermold at the time of the polymerization step.

According to another feature, the skin is composed of a plurality of parts produced on independent molds connected together by floating links.

The invention also relates to an acoustic absorption structure obtained by means of the method defined above, the acoustic absorption structure comprising an acoustically resistive structure, an alveolar structure, a reflective layer and also a plurality of acoustic elements, each comprising an enclosure positioned in the alveolar structure and having an opening delimited by an edge placed against the acoustically resistive structure such that the enclosure and the acoustically resistive structure delimit a cavity. According to the invention, the acoustic absorption structure comprises at least one skin having a plurality of hollow forms connected together by coplanar bands of material, each hollow form being shaped like an enclosure, the skin being intercalated between the alveolar structure and the acoustically resistive structure.

The invention also relates to an aircraft comprising at least one such acoustic absorption structure.

### BRIEF DESCRIPTION OF THE DRAWINGS

Other features and advantages will become apparent from the following description of the invention given solely by way of example with reference to the appended drawings, in which:

FIG. 1 is a perspective view of an acoustic absorption structure that illustrates one prior art embodiment,

FIG. 2 is a perspective view of the acoustic absorption structure that can be seen in FIG. 1 in the course of assembly,

FIG. 3 is a lateral view of an aircraft,

FIG. 4 is a longitudinal section through a part of a conduit of a propulsion assembly of an aircraft,

FIG. 5 is a section through a part of an acoustic absorption structure that illustrates one embodiment of the invention,

FIG. 6 is a transverse section through a mold shaped to obtain a skin forming a plurality of enclosures illustrating one embodiment of the invention,

FIG. 7 is a perspective view of a mold that illustrates one embodiment of the invention,

FIG. 8 is a transverse section through a skin forming a plurality of enclosures placed on the mold that can be seen in FIG. 6 that illustrates one embodiment of the invention,

FIG. 9 s a transverse section through the skin placed on the mold that can be seen in FIG. 8 at the time of a step of being placed together with an alveolar structure that illustrates a first embodiment of the invention,

FIG. 10 is a transverse section through a skin forming a plurality of enclosures placed on a mold at the time of a step of being placed together with an alveolar structure that illustrates a second embodiment,

FIG. 11 is a transverse section through an alveolar structure equipped with a skin forming a plurality of enclosures that illustrates one embodiment of the invention,

FIG. 12 is a top view of an alveolar structure equipped with a skin forming a plurality of enclosures that illustrates one embodiment of the invention, and

FIG. 13 is a transverse section through the alveolar structure that can be seen in FIG. 12.

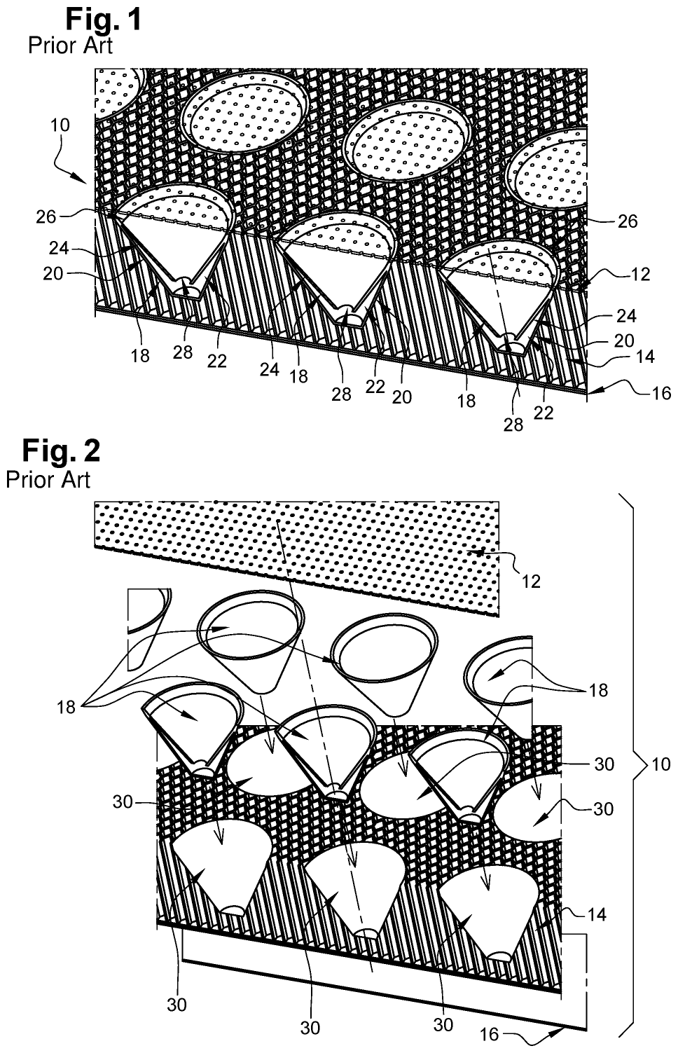

### DETAILED DESCRIPTION OF THE PREFERRED EMBODIMENTS

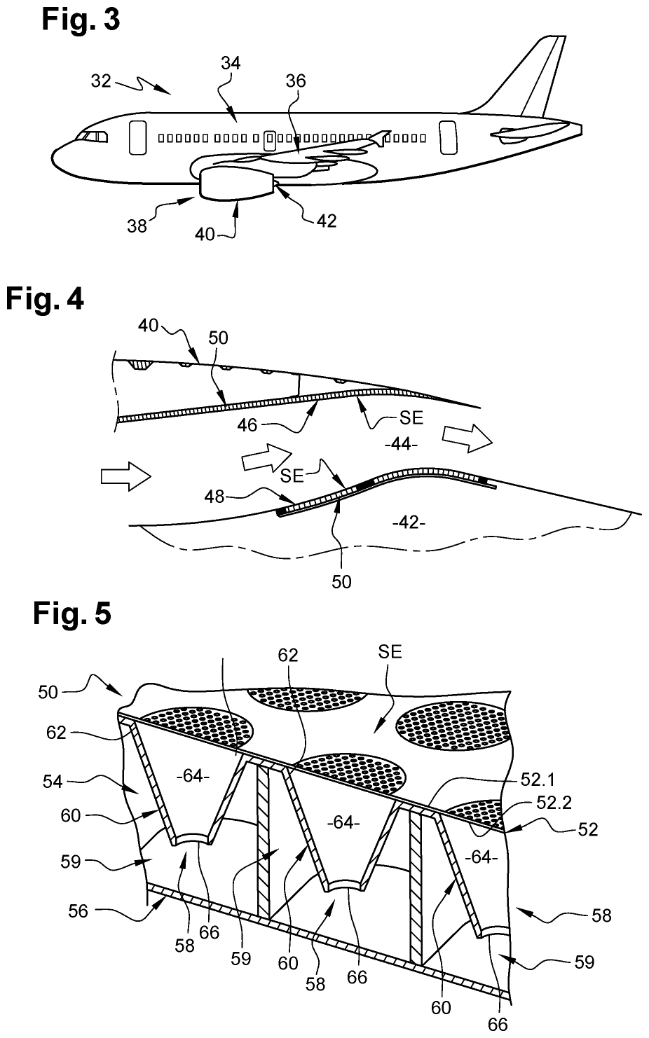

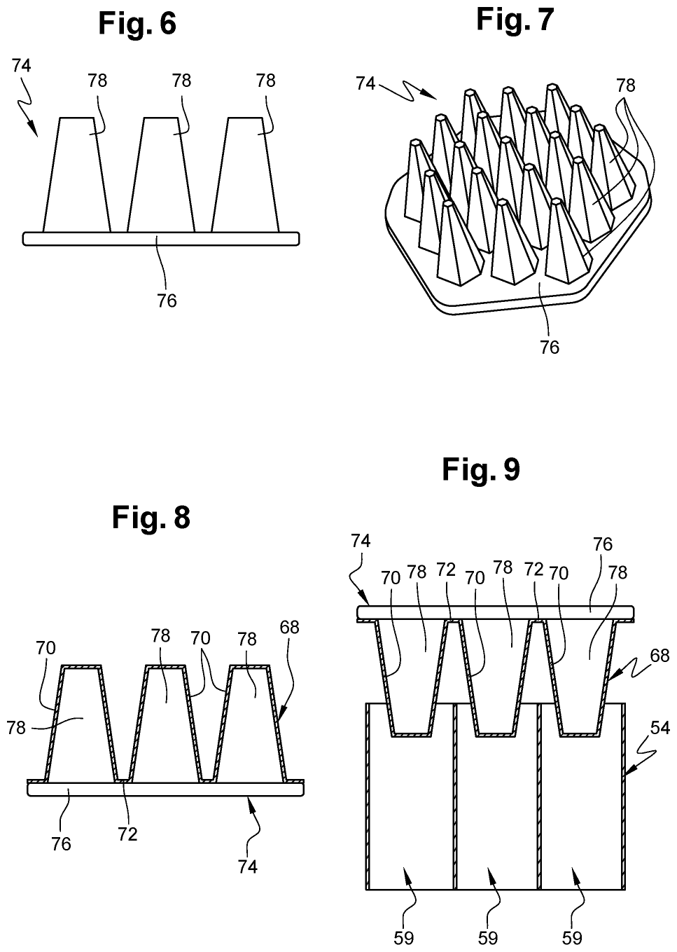

FIG. 3 shows an aircraft 32 that has a fuselage 34, two wings 36 arranged on either side of the fuselage 34, and propulsion assemblies 38 fixed under the wings 36. Each propulsion assembly 38 comprises a nacelle 40 and a turbo engine 42 positioned inside the nacelle 40.

According to one embodiment illustrated in FIG. 4, each propulsion assembly 38 comprises an ejection conduit 44 delimited by an exterior wall 46, integral with the nacelle 40, and by an interior wall 48 integral with the turbo engine 42.

According to one configuration, each interior or exterior wall 46, 48 comprises at least one acoustic absorption structure 50 that has an exterior surface SE in contact with a medium in which soundwaves propagate.

Although described in terms of application to an ejection conduit 44, the invention is not limited to such an application. Thus, the acoustic absorption structure 50 may be positioned at any wall of the aircraft that has an exterior surface in contact with a medium in which soundwaves propagate.

The acoustic absorption structure 50 comprises an acoustically resistive structure 52, having an external face 52.1, forming the exterior surface SE of the acoustic absorption structure 50, an internal face 52.2 opposite the external face 52.1, an alveolar structure 54, a reflective layer 56 and also a plurality of acoustic elements 58 positioned in the alveolar structure 54 against the internal face 52.2 of the acoustically resistive structure 52.

According to one embodiment, the alveolar structure 54 is of the honeycomb type, comprising a plurality of through-cells 59 that are juxtaposed and have a given cross section. According to an embodiment that can be seen in FIG. 5, the acoustically resistive structure 52 comprises at least one panel that is porous at least in line with the acoustic elements 58. Naturally, the invention is not limited to this embodiment. Thus, the acoustically resistive structure 52 could be porous over its entire surface.

According to an embodiment that can be seen in FIG. 5, each acoustic element 58 comprises an enclosure 60, also called a capsule, that has an opening 62 delimited by an edge placed against the internal face 52.2 of the acoustically resistive structure 52 such that the enclosure 60 and the acoustically resistive structure 52 delimit a cavity 64, an acoustic orifice 66 traversing the enclosure 60 to place the cavity 64 in communication with a cell 59 of the alveolar structure 54.

Each enclosure 60 may be frustoconical, as illustrated in FIG. 5, in the form of a truncated pyramid, as illustrated in FIG. 12, or have any other form.

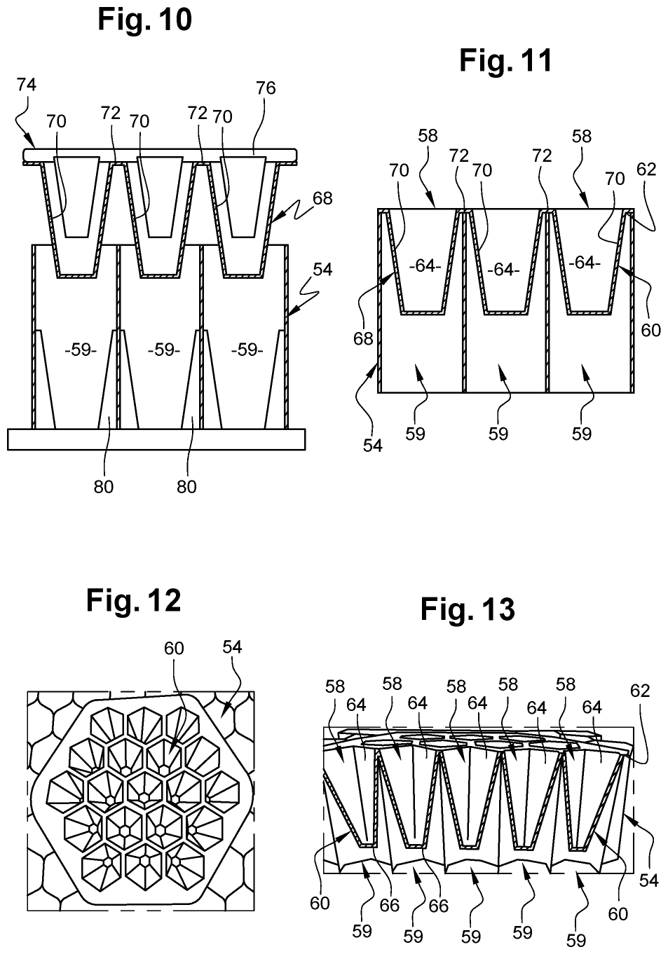

According to another embodiment that can be seen in FIGS. 11 to 13, each acoustic element 58 comprises an enclosure 60, also called a capsule, that has an opening 62 delimited by an edge placed against the internal face 52.2 of the acoustically resistive structure 52 such that the enclosure 60 and the acoustically resistive structure 52 delimit a cavity 64 that is in communication or is not in communication with a cell 59 of the alveolar structure 54.

According to one configuration, the cells 59 of the alveolar structure 54 and the enclosures 60 of the acoustic elements 58 are dimensioned such that each enclosure 60 is accommodated in a cell 59.

According to an arrangement that can be seen in FIG. 5, the acoustic elements 58 are arranged in a plurality of rows and a plurality of columns.

Naturally, the invention is not limited to this arrangement for the acoustic elements 58 and/or to these embodiments.

According to one feature of the invention, the acoustic absorption structure 50 comprises at least one skin 68 having a plurality of hollow forms 70 connected together by coplanar bands 72 of material, each hollow form 70 being shaped like an enclosure 60, the skin 68 being intercalated between the alveolar structure 54 and the acoustically resistive structure 52.

Depending on the case, an acoustic absorption structure 50 comprises a single skin 68 that extends over the entire surface thereof or a plurality of skins 68 intercalated between the alveolar structure 54 and the acoustically resistive structure 52.

According to a first embodiment that can be seen in FIGS. 9 to 13, the hollow forms 70 are dimensioned and arranged such as each to be accommodated in one of the cells 59 of the alveolar structure 54.

According to another embodiment, the hollow forms 70 have a cross section greater than that of the cells 59 of the alveolar structure 54. In this case, the alveolar structure 54 comprises impressions produced by any appropriate means, such as by machining, for example, so that each accommodates a hollow form 70.

According to one feature of the invention, the skin 68 having the hollow forms 70 is obtained by means of a mold 74 having a base 76 on which are positioned projecting forms 78 shaped like the cavities 64 of the acoustic elements 58.

According to one embodiment, the mold 74 is produced from a deformable or flexible material to facilitate demolding and to enable it to adapt to the geometrical imprecisions of the alveolar structure 54. By way of example, the mold 74 is made from silicone.

The skin 68 is produced from a resin. According to one embodiment, the resin is an epoxy resin.

According to another embodiment, the resin is a polyurethane/epoxy mixed resin in order to obtain a flexible skin 68 suitable for being deformed. According to this embodiment, when the skin 68 is secured to the alveolar structure 54 the latter retains its ability to be deformed.

If the resin used confers stiffness on the skin 68 after polymerization, the skin 68 will stabilize the alveolar structure 54 in terms of form when it is secured to the alveolar structure 54. Thus, the mold 74 may have a base 76 that is not planar but shaped to be identical to the acoustic absorption structure 50 to be produced.

According to a first embodiment, the resin is in the form of a film deformed or thermoformed on the mold 74.

According to a second embodiment, the resin is in the liquid or pasty state and deposited on the mold 74 by spraying, by coating or by dipping. In this case, the resin comprises adjuvants to limit its flow. By way of example, the resin is thixotropic on account of a filler.

The method for producing an alveolar structure equipped with a skin 68 forming a plurality of enclosures 60 comprises a step of forming the skin 68 by placing the resin on the mold 74, a step of placing the mold 74 together with the alveolar structure 54 and also a step of polymerization of the resin to simultaneously obtain the hardening of the skin 68 and the joint between the skin 68 and the alveolar structure 54.

In addition to these steps, a method for producing an acoustic absorption structure comprises a step of fitting the acoustically resistive structure 52 and the reflective layer 56.

The resin used for the skin 68 may be partially polymerized at the end of the forming step. In all cases, the resin is not totally polymerized at the end of the placing-together step to obtain the joint between the skin 68 and the alveolar structure 54 at the time of the polymerization step.

At the time of the placing-together step, the resin is intercalated between the mold 74 and the alveolar structure 54. The resin-covered mold 74 is placed on the alveolar structure 54 by inserting the projecting forms 78 of the mold 74 either in the cells 59 or in the impressions of the alveolar structure 54 or the alveolar structure 54 is positioned on the mold 74, causing the projecting forms 78 of the mold 74 to interact either with the cells 59 or with the impressions of the alveolar structure 54.

According to another operating method that can be seen in FIG. 10, prior to the polymerization step, the alveolar structure 54 is positioned on a countermold 80 that has projecting forms penetrating the cells 59 of the alveolar structure 54. In this case, at the time of the polymerization step the skin 68 is intercalated between the mold 74 and the countermold 80. This configuration allows calibration of the thickness of the skin 68.

According to one operating method, the skin 68 of the acoustic absorption structure 50 is composed of a plurality of juxtaposed parts produced on independent molds 74. In this case, the various molds 74 are connected together by floating links such as automatically to adapt to the irregularities of the alveolar structure 54.

The method of the invention makes it possible, simultaneously, to obtain a multitude of enclosures 60 with a relatively thin thickness as compared with that of the enclosures of the prior art acoustic elements obtained by injection, which contributes to reducing the mass of the acoustic elements 58.

When the skin 68 is flexible, it is then possible to deform the alveolar structure 54 in accordance with a required curvature and to stabilize it on this curvature by adhesively bonding the acoustically resistive structure 52 and the reflective layer 56.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for producing an acoustic absorption structure comprising an acoustically resistive structure, an alveolar structure, a reflective layer and also a plurality of acoustic elements each comprising an enclosure positioned in the alveolar structure and having an opening delimited by an edge placed against the acoustically resistive structure such that the enclosure and the acoustically resistive structure delimit a cavity, wherein the method comprises:
forming a skin forming the enclosures of the acoustic elements by depositing a resin on a mold having a base on which are positioned projecting forms shaped like the cavities of the acoustic elements,
placing the mold supporting the resin together with the alveolar structure, the resin being intercalated between the mold and the alveolar structure,
polymerizing the resin to simultaneously obtain a hardening of the skin and also a joint between the skin and the alveolar structure, and
fitting the acoustically resistive structure and the reflective layer.

2. The method according to claim 1, wherein the mold is produced from a deformable or flexible material.

3. The method according to claim 1, wherein the resin is configured such as to confer a stiffness on the skin after the polymerizing step and wherein the mold base is shaped like the acoustic absorption structure to be produced.

4. A method according to claim 1, wherein the resin is configured to obtain a flexible skin after the polymerizing step.

5. A method according to claim 4, wherein the resin is a polyurethane/epoxy mixed resin.

6. The method according to claim 1, wherein the resin is formed as a film deformed or thermoformed on the mold.

7. The method according to claim 1, wherein the resin is in a liquid or pasty state and deposited on the mold by spraying.

8. The method according to claim 1, wherein the resin is in a liquid or pasty state and deposited on the mold by coating.

9. The method according to claim 1, wherein the resin is in a liquid or pasty state and deposited on the mold by dipping.

10. The method according to claim 1, wherein the resin is positioned between the mold and a countermold at a time of the polymerizing step.

11. The method according to claim 1, wherein the skin is composed of a plurality of parts produced on independent molds connected together by floating links.

12. An acoustic absorption structure obtained by means of a method according to claim 1, said acoustic absorption structure comprising:
an acoustically resistive structure,
an alveolar structure,
a reflective layer,
a plurality of acoustic elements each comprising an enclosure positioned in the alveolar structure and having an opening delimited by an edge placed against the acoustically resistive structure such that the enclosure and the acoustically resistive structure delimit a cavity,
at least one skin having a plurality of hollow forms connected together by coplanar bands of material, each hollow form being shaped like an enclosure, said skin being intercalated between the alveolar structure and the acoustically resistive structure.

13. An aircraft comprising at least one acoustic absorption structure according to claim 12.
